(19) United States
(12) Patent Application Publication
(10) Pub. No.: US 2018/0286616 A1
(43) Pub. Date: Oct. 4, 2018

(54) ELECTROMAGNETIC RELAY

(71) Applicant: FUJITSU COMPONENT LIMITED, Tokyo (JP)

(72) Inventors: Nobuo Yatsu, Tokyo (JP); Masahiro Kaneko, Tokyo (JP); Miki Kitahara, Tokyo (JP); Kohei Takahashi, Tokyo (JP); Ying Li, Tokyo (JP); Katsuaki Koshimura, Tokyo (JP); Chuqi Liang, Tokyo (JP)

(21) Appl. No.: 15/928,172

(22) Filed: Mar. 22, 2018

(30) Foreign Application Priority Data
Mar. 30, 2017 (JP) 2017-068845

(51) Int. Cl. H01H 50/56; H01H 50/18

(52) U.S. Cl. CPC H01H 50/56; H01H 50/18

(57) ABSTRACT

An electromagnetic relay includes an electromagnet, an armature configured to be attracted and moved by the electromagnet, and a contact. The contact includes a fixed contact, a movable contact that is brought into contact with and moved away from the fixed contact by the movement of the armature, and a porous part that is formed of a porous metal.

### CROSS-REFERENCE TO RELATED APPLICATION

The present application is based upon and claims the benefit of priority of Japanese Patent Application No. 2017-068845, filed on Mar. 30, 2017, the entire contents of which are incorporated herein by reference.

### BACKGROUND OF THE INVENTION

### 1. Field of the Invention

An aspect of this disclosure relates to an electromagnetic relay.

### 2. Description of the Related Art

An electromagnetic relay is a device for opening and closing an electric circuit. An electromagnetic relay includes an electromagnet, an armature, a movable contact coupled to the armature, and a fixed contact to be brought into contact with the movable contact. In the electromagnetic relay, when an electric current is supplied to the coil of the electromagnet, the armature is attracted to the electromagnet and moves. As a result, the movable contact moves toward and contacts the fixed contact.

The operating time necessary to bring the contacts into contact with each other after the electric current is supplied to the coil is an important factor that determines the performance of the electromagnetic relay. The operating time can be reduced by moving the movable contact at high speed. However, when the movable contact collides with the fixed contact with high energy, an impact noise and vibration are generated. Also, the generated vibration may be transmitted to an external component such as a board and may cause generation of a large vibration noise.

A large number of electromagnetic relays are used in recent automobiles, and electromagnetic relays to be used for automobiles need to meet strict requirements such as quietness.

Japanese Laid-Open Patent Publication No. 2004-311293 discloses an electromagnetic relay whose movable contact and fixed contact are formed of a damping material to reduce the impact and the vibration generated when the contacts contact each other.

When the movable contact and the fixed contact are formed of a damping material different from a noble metal normally used, the contacts may be oxidized, and the contact resistance between the contacts increases, which may cause a problem such as continuity failure. Thus, it is desired to reduce the contact resistance between contacts of an electromagnetic relay.

### SUMMARY OF THE INVENTION

In an aspect of this disclosure, there is provided an electromagnetic relay that includes an electromagnet, an armature configured to be attracted and moved by the electromagnet, and a contact part. The contact part includes a fixed contact, a movable contact that is brought into contact with and moved away from the fixed contact by the movement of the armature, and a porous part that is formed of a porous metal.

### BRIEF DESCRIPTION OF THE DRAWINGS

FIG. 1 is drawing illustrating a configuration of an electromagnetic relay according to a first embodiment;

FIG. 2 is an enlarged view of a contact spot G;

FIG. 3 is an enlarged view of a porous part according to a second embodiment;

FIGS. 4A and 4B are enlarged views of a fixed spring according to a third embodiment;

FIG. 5 is an exploded perspective view of a contact according to a variation of the first embodiment; and

FIGS. 6A and 6B are drawings illustrating a process of assembling the contact of FIG. 5.

### DESCRIPTION OF EMBODIMENTS

Embodiments of the present invention are described below with reference to the accompanying drawings.

Electromagnetic relays according to embodiments of the present invention are described below with reference to the accompanying drawings. The same reference number is assigned to the same component throughout the drawings, and repeated descriptions of that component may be omitted.

### First Embodiment

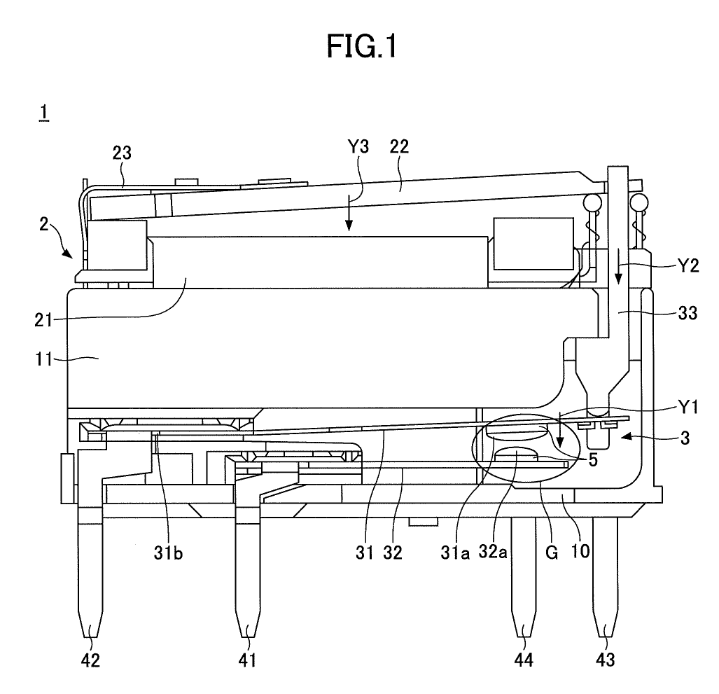

FIG. 1 is a drawing illustrating an electromagnetic relay 1 according to a first embodiment. In FIG. 1, a case of the electromagnetic relay 1 is omitted. The electromagnetic relay 1 includes an electromagnetic part 2 and a contact 3.

The electromagnetic part 2 includes an electromagnet 21 including a coil and an iron core that are covered by a resin. The electromagnet 21 generates a magnetic force when an electric current is supplied to the coil, and stops generating the magnetic force when the supply of the electric current is stopped.

The electromagnetic relay 1 also includes a base 10 that includes a support 11 and is formed of an electrical insulating resin. The electromagnet 21 is placed on the base 10 and is supported by the support 11. The coil of the electromagnet 21 is connected to coil terminals 43 and 44.

The electromagnetic part 2 includes a plate-shaped armature 22 that is formed of magnetic material such as iron and is to be attracted by the electromagnet 21. A plate spring 23 is fixed to the armature 22 and to the base 10. The plate spring 23 has elasticity and biases the armature 22 in a direction away from the electromagnet 21.

The contact 3 includes a movable spring 31 and a movable contact 31a attached to the movable spring 31. The movable spring 31 is shaped like a plate, is formed of a conductive copper, and has elasticity. An end 31b of the movable spring 31 is fixed to the base 10. The movable spring 31 is connected to a movable terminal 42 to be connected to an external electric circuit.

The contact 3 also includes a fixed spring 32 used as a fixed plate and a fixed contact 32a attached to the fixed spring 32. The fixed spring 32 is shaped like a plate and formed of copper. The fixed spring 32 is fixed to the base 10 so as to face the movable spring 31. The movable contact 31a and the fixed contact 32a are disposed to face each other. The fixed spring 32 is connected to a fixed terminal 41 to be connected to an external electric circuit.

The contact 3 further includes a card 33 that is a coupling for transferring the movement of the armature 22 to the movable spring 31. The card 33 is coupled to the movable spring 31 and to the armature 22 that is opposite the end of the armature 22 to which the plate spring 23 is fixed. The card 33 is configured to be movable in the case in a direction Y2 and in the opposite direction. The card 33 transfers the movement of the armature 22 to the movable spring 31.

While no electric current is supplied to the coil of the electromagnet 21, the armature 22 is positioned apart from the electromagnet 21 due to the biasing force of the plate spring 23. In this state, the movable spring 31 is positioned apart from the fixed spring 32, and the movable contact 31a is electrically disconnected from the fixed contact 32a.

When an electric current is supplied to the coil of the electromagnet 21, a magnetic field is generated around the iron core of the electromagnet 21, and the armature 22 is attracted to the electromagnet 21 in direction Y3. Then, the armature 22 presses the card 33, and the card 33 moves in the direction Y2 and presses the movable spring 31. When pressed by the card 33, the movable spring 31 curves and moves toward the fixed spring 32 in direction Y1. The movable contact 31a moves toward and contacts the fixed contact 32a. As a result, the movable contact 31a and the fixed contact 32a are connected to each other.

When the supply of the electric current to the coil is stopped, the armature 22 moves in a direction away from the electromagnet 21 due to the elasticity of the plate spring 23. As a result, the armature 22 moves upward and causes the card 33 to move in a direction opposite to the direction Y2. Then, the movable contact 31a moves away from and is disconnected from the fixed contact 32a.

The movable contact 31a and the fixed contact 32a may be formed of gold, silver, or an alloy of, for example, silver and tin oxide or silver and nickel.

According to the first embodiment, the contact 3 further includes a porous part 5 made of porous metal as described below.

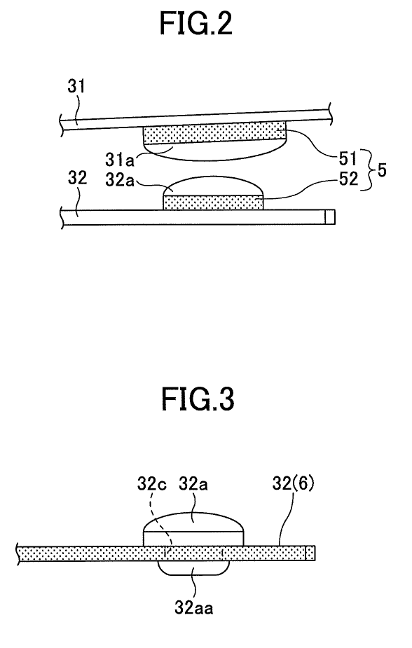

The porous part 5 is described with reference to FIG. 2 that is an enlarged view of a contact spot G in FIG. 1.

As illustrated in FIG. 2, the porous part 5 includes a porous part 51 disposed between the movable contact 31a and the movable spring 31 and a porous part 52 disposed between the fixed contact 32a and the fixed spring 32. The porous part 51 and the porous part 52 have substantially the same structure and formed of substantially the same material. The porous part 51 and the porous part 52 may be collectively referred to as the porous part 5 when it is not necessary to distinguish them.

The porous part 51 is formed of silver or copper with low electrical resistivity, and has a circular shape whose radius is substantially the same as the radius of the movable contact 31a. The porous part 51 is welded to the movable contact 31a and the movable spring 31. The configuration of the porous part 52 is substantially the same as that of the porous part 51, and therefore detailed descriptions of the porous part 52 are omitted.

In the present embodiment, a porous metal indicates a metal that includes a large number of cells whose frames and/or sides are formed of the metal and whose diameter is from several pm to several cm.

The porous part of the present embodiment may be made of either an “open cell” porous metal having a cell structure where the frames of cells are formed and the boundaries between the cells are open, or a “closed cell” porous metal having a cell structure where the boundaries between cells are also formed and the cells are separated from each other.

A porous metal has a porous structure having a large specific surface area and is getting attention as a high-performance material having a high energy-absorption capability, a high heat-exchange capacity, high thermal-insulating properties, high sound-absorption properties, and so on.

A porous metal has a wide range of spring constants and a high Poisson ratio in the surface layer. Therefore, a comparatively-thin layer of a porous metal can absorb vertical and horizontal displacements caused by micro vibrations with different sizes and directions and can prevent resonance phenomena. In the cross section of a porous metal, the thin-dense-thin density structure changes continuously. Therefore, a porous metal can suppress a wide range of vibrations from micro vibrations to heavy vibrations.

The porous part 5 may be formed by, for example, powder space holder (PSH)—metal injection molding (MIM), blowing-agent friction-stir-welding (FSW), or mold casting using high-pressure gas.

In the PSH-MIM, a pore-forming agent with a melting point higher than the molding temperature is added as a third material to an MIM material obtained by mixing a binder and metal powder, the obtained mixture is heated and kneaded to prepare a porous material, the porous material is molded into a desired shape, and the molded porous material is degreased and sintered to obtain a porous metal.

In the blowing-agent friction-stir-welding, a blowing agent (TᵢH₂) is sandwiched between two metal plates, the blowing agent is mixed with the metal plates when welding the metal plates together by the friction stir welding (FSW), and a mixed portion is cut out and heated to obtain a porous metal.

In the mold casting using high-pressure gas, a metal is melted by high-frequency heating in a crucible under a high-pressure gas environment, a gas is dissolved in the melted metal, and the melted metal including the dissolved gas is poured into a mold including a cooled copper plate on the bottom to solidify the melted metal in one direction from the bottom to the top and obtain a porous metal.

A closed-cell porous metal has electrical resistivity lower than that of an open-cell porous metal, and is therefore preferable. Also, a porous metal used for the porous part 5 may be obtained by molding conductive metal fibers and welding only the portions of the metal fibers contacting each other by applying electricity to the metal fibers, or by sintering spherical fine metal powder at a temperature around its melting point.

In FIG. 2, the porous part 51 is provided between the movable contact 31a and the movable spring 31 and the porous part 52 is provided between the fixed contact 32a and the fixed spring 32. However, only one of the porous parts may be provided.

In the electromagnetic relay 1 described above, the movable contact 31a and the fixed contact 32a that directly contact each other are formed of a material normally used for contacts and have a shape of normal contacts. Therefore, the contact resistance between the movable contact 31a and the fixed contact 32a can be made low. Also, the porous part 51 and the porous part 52 can absorb the impact vibration and the impact noise that are generated in the contact spot G when the movable contact 31a and the fixed contact 32a collide with each other with high energy. With this configuration, it is possible to prevent the impact vibration from being transmitted from the fixed terminal 41 and the movable terminal 42 to, for example, an external board and generating a large vibration noise because the impact vibration is absorbed in the contact spot G. Thus, the electromagnetic relay 1 of the embodiment can improve the quietness.

### Second Embodiment

Next, an electromagnetic relay according to a second embodiment is described with reference to FIG. 3. FIG. 3 is an enlarged view of a porous part 6 according to the second embodiment. The components of the electromagnetic relay of the second embodiment are substantially the same as those of the electromagnetic relay 1 of the first embodiment except for the porous part 6. Therefore, descriptions of the same components are omitted here.

In the electromagnetic relay of the second embodiment, the fixed spring 32 is implemented by the porous part 6. The fixed spring 32 can be formed of a porous metal because the fixed spring 32 does not particularly require elasticity.

The fixed contact 32a is formed of the same material as in the first embodiment. In the second embodiment, the porous part 51 may be provided between the movable spring 31 and the movable contact 31a.

The fixed contact 32a includes an insertion part 32aa that is inserted into a through hole 32c of the fixed spring 32. As illustrated in FIG. 3, the fixed contact 32a is attached to the fixed spring 32 by inserting the insertion part 32aa into the through hole 32c and flattening or fusing the end of the insertion part 32aa.

In the second embodiment, the movable contact 31a and the fixed contact 32a are made of a normal material and formed in a normal shape to achieve low contact resistance, and the fixed spring 32 is formed of a porous metal to reduce the noise generated when the contacts contact each other. Thus, the second embodiment also makes it possible to provide a quiet, high-performance electromagnetic relay.

### Third Embodiment

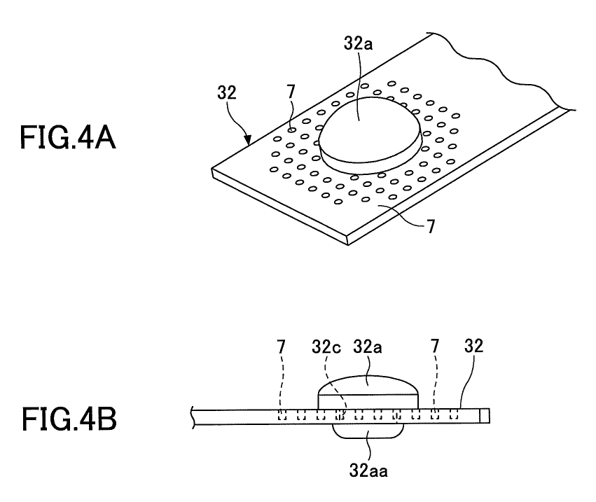

Next, an electromagnetic relay according to a third embodiment is described with reference to FIGS. 4A and 4B. FIGS. 4A and 4B are enlarged views of a fixed spring according to the third embodiment. FIG. 4A is an enlarged perspective view and FIG. 4B is a side view of a portion of the fixed spring 32. The components of the electromagnetic relay of the third embodiment are substantially the same as those of the electromagnetic relay 1 of the first embodiment except for the fixed spring 32 and the fixed contact 32a.

In the electromagnetic relay of the third embodiment, multiple holes 7 are formed in a portion of the fixed spring 32 around the fixed contact 32a. The fixed contact 32a is formed of the same material as in the first embodiment. The fixed contact 32a includes an insertion part 32aa that is inserted into a through hole 32c of the fixed spring 32. As illustrated in FIG. 4B, the fixed contact 32a is attached to the fixed spring 32 by inserting the insertion part 32aa into the through hole 32c and flattening or fusing the end of the insertion part 32aa. Alternatively, the fixed contact 32a may be welded to the fixed spring 32.

Although the illustration is omitted, multiple holes 7 may also be formed in the movable spring 31 around the movable contact 31a.

Further, both the holes 7 and the porous part 5 may also be used. For example, the holes 7 may be formed in one of the movable spring 31 and the fixed spring 32, and the porous part 5 may be provided on the other one of the movable spring 31 and the fixed spring 32.

In FIG. 4B, the holes 7 do not pass through the fixed spring 32. However, the holes 7 may be formed as through holes passing through the fixed spring 32 and/or the movable spring 31. The holes 7 may have any shape that can absorb the impact vibration and the impact noise generated when the contacts contact each other.

In the third embodiment, the movable contact 31a and the fixed contact 32a are made of a normal material and formed in a normal shape to achieve low contact resistance, and the holes 7 are formed in the fixed spring 32 and/or the movable spring 31 to reduce the noise generated when the contacts contact each other. Thus, the third embodiment also makes it possible to provide a quiet, high-performance electromagnetic relay.

### Variation

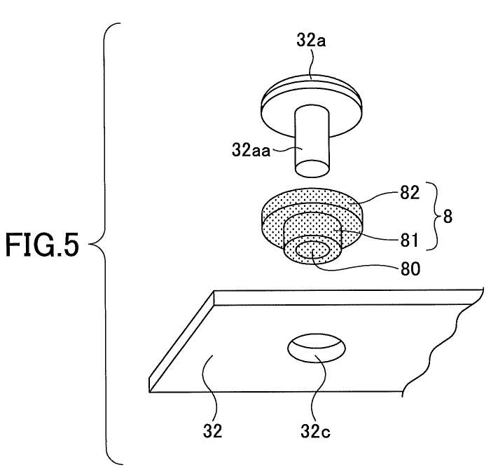

Next, an electromagnetic relay according to a variation of the first embodiment is described with reference to FIG. 5. FIG. 5 is an exploded perspective view of a contact of the electromagnetic relay according to the variation. For brevity, FIG. 5 illustrates only a porous part 8 disposed on the fixed spring 32.

In the electromagnetic relay of FIG. 5, the porous part 8 provided between the fixed spring 32 and the fixed contact 32a is shaped like a grommet having a through hole.

The porous part 8 includes a tubular part 81 in which a through hole 80 is formed and a flange 82 formed on the upper edge of the tubular part 81. The outside diameter of the tubular part 81 is set such that the tubular part 81 can be inserted into a through hole 32c of the fixed spring 32, and the diameter of the through hole 80 or the inside diameter of the tubular part 81 is set such that an insertion part 32aa of the fixed contact 32a can be inserted into the through hole 80.

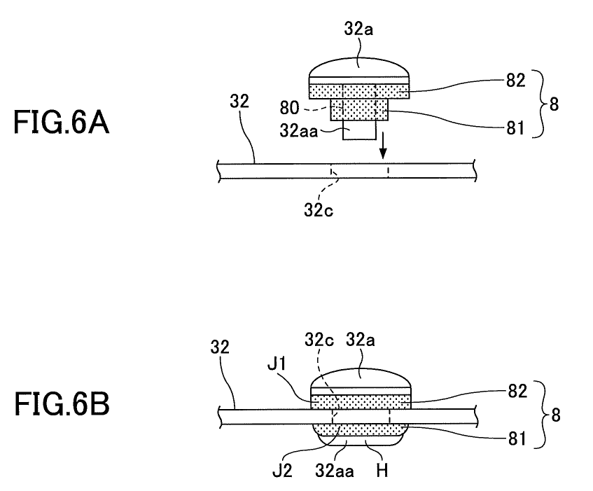

As illustrated in FIG. 6A, the insertion part 32aa is inserted into the through hole 80. The insertion part 32aa is longer than the porous part 8 and protrudes from the lower end of the porous part 8.

The tubular part 81 is inserted into the through hole 32c, and as illustrated in FIG. 6B, the lower end of the insertion part 32aa protruding from the bottom surface of the fixed spring 32 is flattened or fused to fix the porous part 8 to the fixed spring 32. This process is preferably performed such that the porous part 8 is present between the insertion part 32aa and the fixed spring 32, and the insertion part 32aa does not directly contact the fixed spring 32.

As illustrated in FIG. 6B, the porous part 8 includes a region J1 positioned between the upper surface of the fixed spring 32 and the fixed contact 32a and a region J2 positioned between the lower surface of the fixed spring 32 and a flattened portion H of the insertion part 32aa. A transfer contact can be implemented by using the flattened portion H as a movable contact.

In the variation described above, the porous part 8 may also be provided between the movable spring 31 and the movable contact 31a.

Electromagnetic relays according to the embodiments are described above. However, the present invention is not limited to the specifically disclosed embodiments, and variations and modifications may be made without departing from the scope of the present invention. Also, the first through third embodiments and the variation may be combined in any appropriate manner.

An aspect of this disclosure makes it possible to reduce the noise generated when contacts of an electromagnetic relay contact each other while maintaining the contact resistance between the contacts at a low level, and thereby makes it possible to provide a quiet, high-performance electromagnetic relay.

What is claimed is:

1. An electromagnetic relay, comprising:
an electromagnet;
an armature configured to be attracted and moved by the electromagnet; and
a contact including
a fixed contact,
a movable contact that is brought into contact with and moved away from the fixed contact by the movement of the armature, and
a porous part that is formed of a porous metal.

2. The electromagnetic relay as claimed in claim 1, wherein
the contact further includes
a movable spring to which the movable contact is attached, and
a fixed spring to which the fixed contact is attached; and
the porous part is provided in at least one of a position between the movable contact and the movable spring and a position between the fixed contact and the fixed spring.

3. The electromagnetic relay as claimed in claim 1, wherein
the contact further includes
a movable spring to which the movable contact is attached, and
a fixed spring to which the fixed contact is attached; and
the fixed spring is the porous part.

4. An electromagnetic relay, comprising:
an electromagnet;
an armature configured to be attracted and moved by the electromagnet; and
a contact including
a movable contact,
a movable spring to which the movable contact is attached,
a fixed contact, and
a fixed spring to which the fixed contact is attached,
wherein multiple holes are formed in at least one of the movable spring and the fixed spring.
